(19) United States
(12) Patent Application Publication
(10) Pub. No.: US 2005/0243950 A1
(43) Pub. Date: Nov. 3, 2005

(54) Spectral jitter analysis

(76) Inventors: Bernd Laquai, Stuttgart (DE); Marcus Mueller, Stuttgart (DE)

Correspondence Address: PERMAN & GREEN, 425 POST ROAD, FAIRFIELD, CT, 06824, US

(21) Appl. No.: 10/498,609

(22) PCT Filed: May 3, 2002
(86) PCT No.: PCT/EP02/04841

§ 371 Date: Jun. 17, 2005

(51) Int. Cl. H04B 17/00

(52) U.S. Cl. 375/326

(57) ABSTRACT

A plurality of error values are determined for providing a jitter analysis for a digital signal having transitions between logical levels. Each error value is associated with one of a plurality of successive timing points, and is derived from a comparison of a result of a detection for a transition occurring in the digital signal at its associated timing point with an expected signal. An error signal is provided representing the derived error values relative to their respective timing points, and a spectral jitter analysis is provided for the error signal in order to detect spectral components in the error signal.

### BACKGROUND OF THE INVENTION

The present invention relates to jitter analysis for digital signals.

Characterization of the transient behavior of high-speed digital circuits, i.e. the transition from a logical zero to a logical one and vice versa, has become increasingly important for designing as well as manufacturing such digital circuits. Timing instabilities such as jitter can cause single transmission errors, or temporary or even permanent outage of an entire communication system, and have to be avoided. The standard overall figure of merit for a communications system is the Bit Error Rate (BER), however a high value of BER does not necessarily indicate timing problems, as there are many other potential sources of error in a system (for example level/threshold mismatch).

One of the key specifications of high-speed circuits with respect to timing is Jitter. ITU-T G.701 defines jitter as short-term non-cumulative variations of the significant instants of a digital signal from their ideal positions in time. The significant instant can be any convenient, easily identifiable point on the signal such as the rising or falling edge of a pulse or the sampling instant. By plotting the relative displacement in the instants between an ideal pulse train and a real pulse train that has some timing jitter, the so-called jitter function is obtained. In addition to the jitter time function, the jitter spectrum can be displayed in the frequency domain. Jitter can also be displayed using so-called Jitter-Histograms showing the likelihood for a transition.

Jitter histograms can be measured using an oscilloscope, a time interval analyzer, or a BER Tester. The applicant Agilent Technologies provides various BER test equipment such as the Agilent® 81250 ParBERT®. The histogram values are obtained from a BER vs. Sample Delay measurement (generally referred to as the so-called bathtub curve) by taking the absolute value of the derivative.

Various ways for jitter analysis are disclosed in the European Patent applications Nos. 02007690.7 or 02006259.2.

### SUMMARY OF THE INVENTION

It is an object of the invention to provide an improved jitter analysis. The object is solved by the independent claims. Preferred embodiments are shown by the dependent claims.

According to the present invention, a jitter analysis is provided for a digital signal to be measured having transitions between logical levels. At each of a plurality of successive timing points, a detection for a transition occurring in the signal at that timing point is provided. The result of the detection is compared with an expected signal, and an error value is derived therefrom for each timing point. Each error value represents a matching information between a detected transition (or non-transition) and an expected transition (or non-transition) for the respective timing point.

An error signal is then provided representing the derived error values relative to its respective timing points, or in other words, the error signal represents the plurality of the derived error values, each error value being associated with its respective timing point. The error signal thus shows the variation of the error values, with the variation might be provided over the time (absolute or relative time scale) or any other scale derived from the timing points. Thus, the error signal can be e.g. the derived error values over the plurality of successive timing points. Instead of the plurality of successive timing points, other bases of the error values in the error signal can be derived from the plurality of successive timing points, such as an absolute or relative time scale. Accordingly a pseudo time scale can be provided with the plurality of successive timing points as successive events independent of the actual time difference between successive events. This is in particular useful in case the error values are sampled periodically.

A spectral jitter analysis is then provided for the error signal in order to detect spectral components in the error signal which might represent relevant spectral information of jitter contained in the digital signal. It will be appreciated that substantially any known method for spectral analysis can be applied for the spectral jitter analysis of the error signal, such as auto-correlation, cross-correlation, Fourier-Analysis, etc. Preferred examples for spectral analysis are disclosed e.g. in A. Papoulis: Probability, Random Variables and Stochastic Processes, McGraw Hill 1965, or in J. S. Bendat: A. G. Piersol, Random Data, John Whiley&Sons, 1986. It goes without saying that the specific context of different measurements might render one or more of the known spectral analysis method more or less applicable.

The invention thus allows analyzing the digital signal for spectral components resulting from jitter influences. Such spectral components might then be applied for taking further actions e.g. to avoid or reduce jitter at specific frequencies or for quality checks. Preferred examples are evaluating quantitative presence of known spectral jitter components in the digital signal or a pass/fail test if one or more such known spectral jitter components exceed one or more given thresholds.

The timing points for detecting transitions in the digital signal are preferably selected in ranges wherein transitions are likely (e.g. under the influence of jitter). Preferably, timing points are selected substantially in the middle of such range wherein transitions are likely under the influence of jitter. Such transition ranges can be determined e.g. using known techniques such as the aforementioned Jitter Histograms, bit error rate (BER) measurements, or eye diagram measurements, etc.

In a preferred embodiment wherein transitions in the digital signal are related to a reference signal (e.g. a clock signal) having a reference frequency, the distance between successive timing points is preferably derived from the reference frequency (e.g. as the period, or multiples or fraction thereof, of the reference frequency). The timing points are preferably selected at timings when transitions are expected without influence of jitter, preferably in the middle of a transition area as e.g. determined using an aforementioned eye-diagram.

The transition detection is possible in various ways, preferably by detecting the signal value at a level threshold at a given reference timing point (BER test equipment) or by evaluating the sampled signal waveform (Oscilloscope).

The invention can be partly or entirely embodied or supported by one or more suitable software programs, which can be stored on or otherwise provided by any kind of data carrier, and which might be executed in or by any suitable data processing unit. The invention may also be partly or entirely embodied or supported by dedicated electronic hardware not related to software or firmware execution such as an hardwired ASIC. Accordingly, combinations of software and hardware solutions might also be employed.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIGS. 1-3 illustrate an embodiment with sinusoidal jitter modulation onto a random digital data signal.

FIGS. 4-7 illustrate an embodiment with sinusoidal jitter modulation and random jitter content onto a random digital data signal.

### DETAILED DESCRIPTION OF EMBODIMENTS OF THE INVENTION

For validation and characterization of digital circuit designs, it is of advantage not only to quantify the amount of jitter measured but also to analyze it for its spectral content to localize its origin and understand the mechanisms of interference. In order to allow elimination or reduction of deterministic jitter in a design, the generated jitter is analyzed for its deterministic content by decomposing it into its spectral contents. Whereas the energy of random jitter modulation is generally spread into wide frequency band, deterministic jitter usually manifests itself with a concentration of energy into (e.g. a few) discrete modulation frequencies. The ability to determine those frequencies might provide insight into root causes and can therefore significantly speed up the debugging process.

In the following, preferred embodiments are described for providing spectral analysis on jitter measured with a bit error rate tester (BERT) such as the aforementioned Agilent® 81250 ParBERT®. However, it is clear that the invention is not limited to BERTs, but that any other test equipment can be provided for deriving the error signal from comparing detected with expected transitions at defined timing points or sampling and evaluating the entire signal waveform.

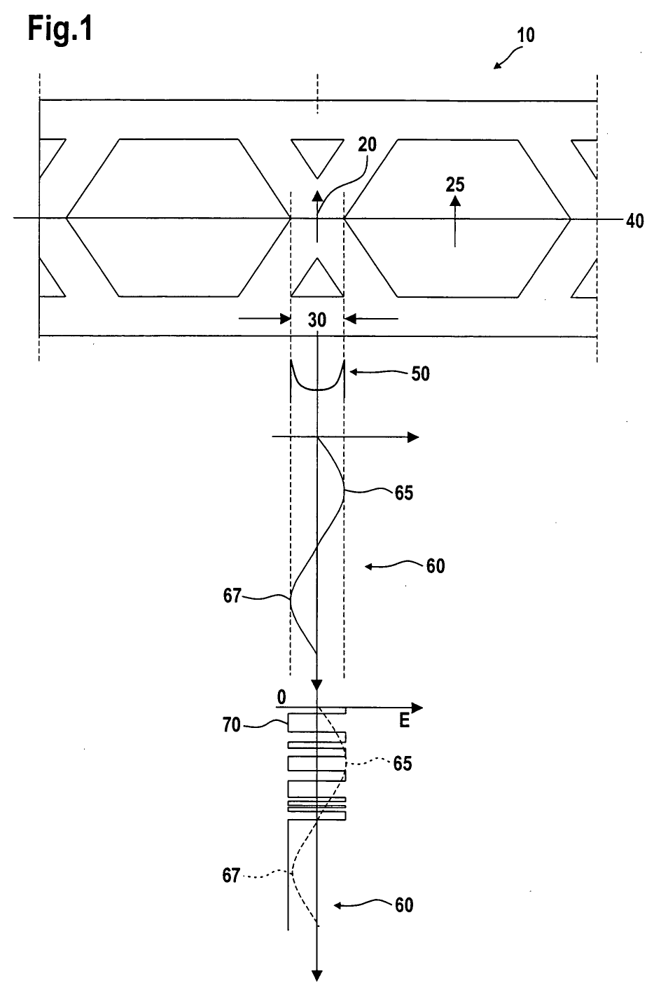

FIG. 1 illustrates principles of a preferred embodiment. The upper part shows a typical eye diagram 10 with a plurality of transitions superimposed. For the sake of clarity, only the ‘borders’ of superimposed lines are shown. A sampling point 20 is selected to be within a transition range 30 determined by all detected transitions occurring at a given threshold level 40. Preferably, the sampling point 20 is selected substantially in the middle of the transition range 30 for a given threshold level 40 of substantially 50%. The sampling point 20 might also be selected using a Jitter Histogram 50, and is preferably selected at the center of gravity of the Jitter Histogram 50.

At the sampling point 20, strobing is provided by comparing each detected signal value with the value expected in the ‘center’ of the data eye (e.g. in the eye to the right, indicated by a reference timing point 25). Whenever a transition is displaced such that the data eye closes (displacement to the right in the eye diagram 10 of FIG. 1), the strobing will result in an error.

For the sake of better understanding, a sinusoidal jitter modulation 60 onto a random digital data signal shall be assumed. While the random data signal allows an easier explanation, it is clear that the invention can be applied for any kind of digital signal. Without the jitter modulation 60, all transitions of the digital data signal would occur precisely at the sampling point 20. However, the jitter modulation 60 will periodically displace the transitions of the digital data signal ‘around’ the sampling point 20, thus leading to the transition range 30. Just from looking at the jitter histogram 50, no conclusion can be made on the frequency of the jitter modulation 60.

Whenever the jitter modulation 60 displaces the transitions to the right in FIG. 1 and comparison is performed e.g. to the value as expected at the reference timing point 25 of the right data eye center, the strobing will result in errors. Due to the displacement of the transitions, the value of the left data bit is actually compared to what is expected at the reference timing point, thus resulting in an error.

Since we assume random data, the BER will be 0.25, because in 50% of the cases during the positive portion 65 of the jitter modulation sine wave 60 adjacent bits are equal in value and no transition will occur between the sampled and the expected bit. Thus the jitter has no impact on that particular bit. In contrary, when the displacement is opposite (i.e. during the negative portion 67 of the jitter modulation sine wave 60 no error will occur. No error occurs, because the data eye to the right is opened by the displacement (displacement to the left in FIG. 1) which allows to sample the expected value despite the offset of the current sampling point 20 to the reference data point 25. Thus, the error signal 70 (with the errors E depicted over the time) is modulated in its error density according to the jitter frequency of the jitter modulation 60.

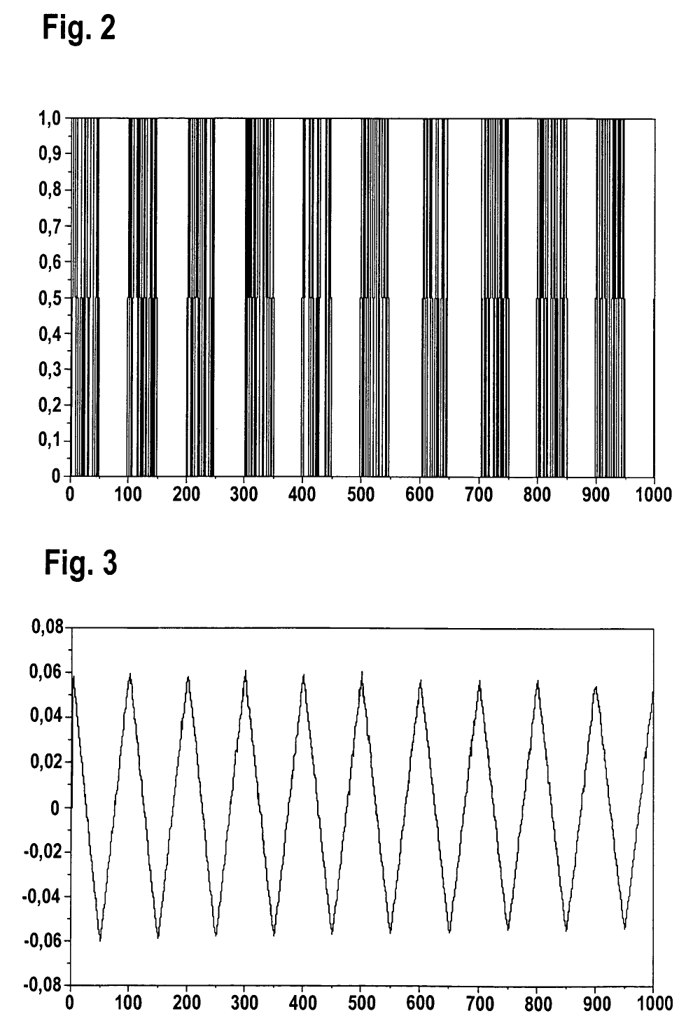

FIG. 2 shows the result of a simulation of what is shown schematically in FIG. 1. FIG. 2 represents the logical values (represented by 0 and 1) of the generated error signal 70 over the time. The error signal 70 shows a periodic modulation of the error density. The periodicity appears as a segment with zero errors followed by a segment with 50% errors.

A well-know statistical method to extract periodic information buried in a random signal is the calculation of the auto-correlation function (as illustrated in more detail e.g. in the aforementioned references by Papoulis or Bendat). The auto-correlation function of a true random signal vanishes after a small bandwidth related delay, whereas any kind of periodic signal yields an auto-correlation function with the same periodicity that does not vanish even for large delays. Therefore the periodic information can be extracted from the auto-correlation function by evaluating the behavior for large delays. FIG. 3 shows the auto-correlation function of the error signal as shown in FIG. 2. FIG. 3 depicts the value of the auto-correlation versus the correlation delay. The jitter frequency of the jitter modulation 60 can then be derived by evaluating the periodicity of the auto-correlation function, preferably by calculation of its Fourier transform. According to the Theorem of Wiener-Chintchine (as also illustrated in more detail e.g. in the aforementioned references by Papoulis or Bendat), the Fourier transform of the auto-correlation function represents the spectral power density of the error signal. Since the error signal reflects the periodicity of the jitter, the obtained spectrum represents the spectral information caused by the jitter modulation.

An alternative way to obtain the same spectral information is by directly calculating the Fourier transform of the error signal. The obtained (complex) values of the Fourier transform may then be multiplied with its conjugate complex values. The result is the same spectral power density of the error signal as obtained by calculating the Fourier transform of the auto-correlation function.

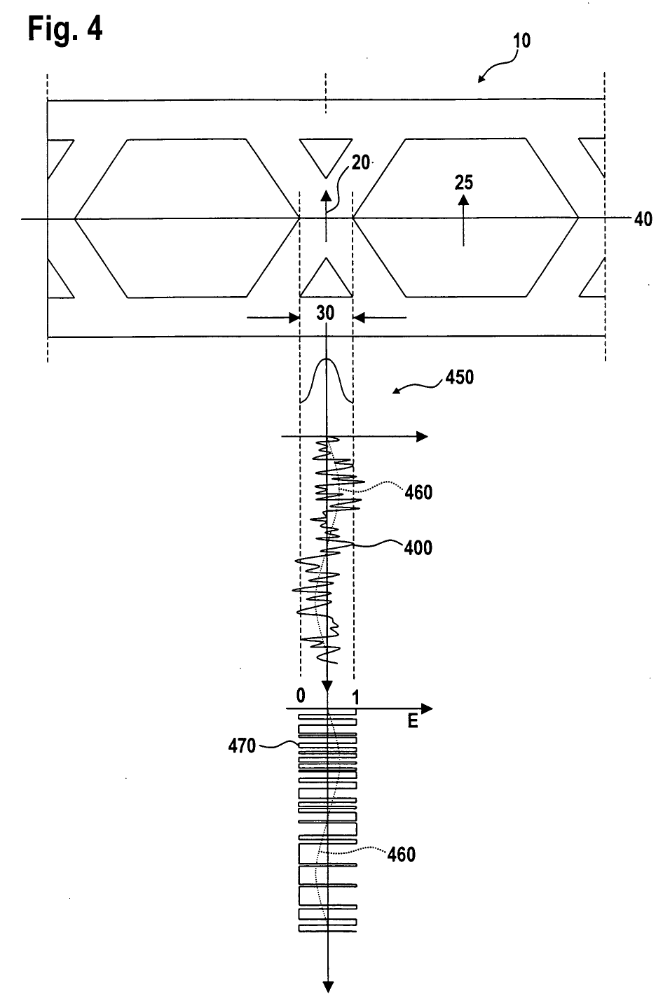

Pure sinusoidal jitter rarely occurs in reality. Typically real systems show intrinsic random jitter caused by thermal and scattering noise. Since it is the result of many different uncorrelated contributors the intrinsic random jitter generally shows up with a Gaussian distribution. An example where sinusoidal jitter artificially injected and intrinsic random noise is mixed is shown in FIG. 4.

As long as the peak-to-peak amplitude of the sinusoidal jitter 460 (dotted line) does not substantially exceed the rms value of the random jitter 400, the distribution of the composite jitter in the Jitter Histogram 450 still shows up with a bell like distribution that makes separation of sinusoidal and random jitter difficult.

When random and sinusoidal jitter are mixed and the sinusoidal jitter 460 does not exceed the random jitter 400 by far, the error signal 470 generated by sampling in the sampling point 20 (here: crossover point of the transitions) again shows up with a periodic modulation of the error density. The difference to the pure sinusoidal jitter (as depicted in FIG. 1) is that now the negative portion of the sinusoid also generates errors but with smaller density than during the positive portion. Therefore the periodicity of the sinusoidal jitter 460 gets transferred in a similar way into the error signal 470 and can be extracted e.g. by calculation of the auto-correlation function or the spectral density function.

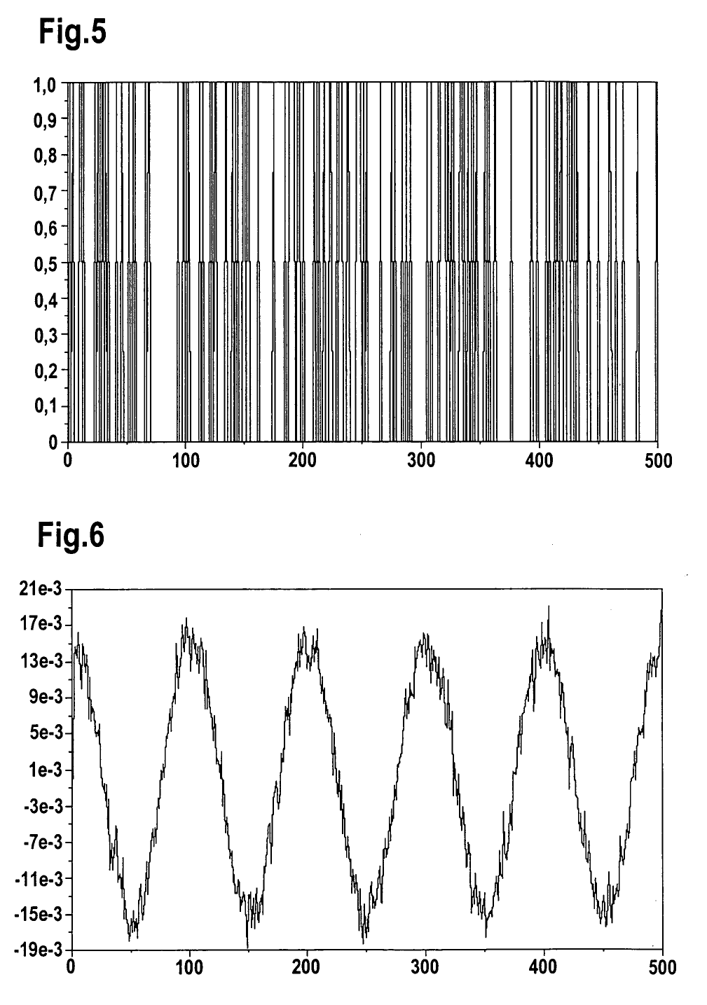

FIG. 5 shows a simulated error signal 470 caused by sinusoidal and random jitter. The periodicity in the error density is hardly visible and the signal appears to have a random character.

FIG. 6 shows the auto-correlation function calculated from the error signal as shown in FIG. 5. Due to the fact that it is calculated on a limited sample set the result shows a certain noise. By increasing the sample set, however, the amplitude of this noise can be reduced. The auto-correlation function clearly shows the periodic signal buried in the error signal. Thus a more linear mapping of the jitter modulation 460 into the error signal 470 can be achieved. Since the error density is modulated more smoothly in an analog way the auto-correlation function fully represents the sinusoidal jitter modulation with the respective periodicity.

Since a broadband noise signal represents a continuous flat power density spectrum, the energy is equally distributed over a wide range of frequencies and thus is typically small in magnitude in a narrow section of the spectrum. In contrary when a periodic signal is contained in a broadband noise signal the power density of the periodic signal is strongly concentrated in few discrete lines and can clearly be distinguished from the broadband noise power density.

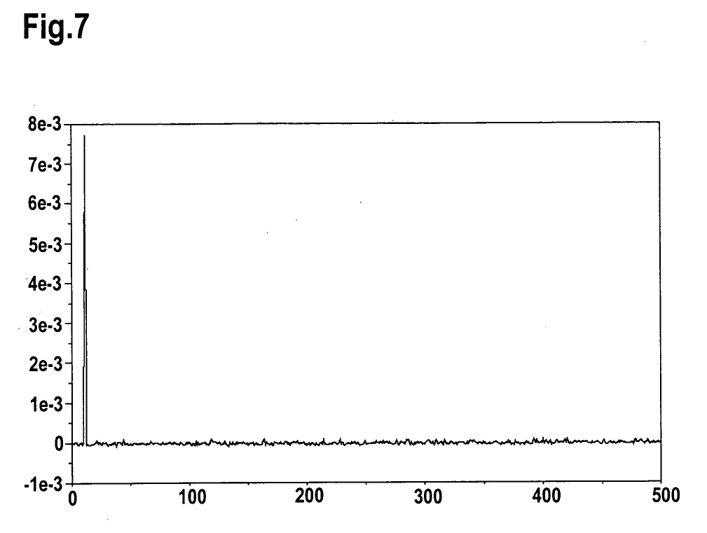

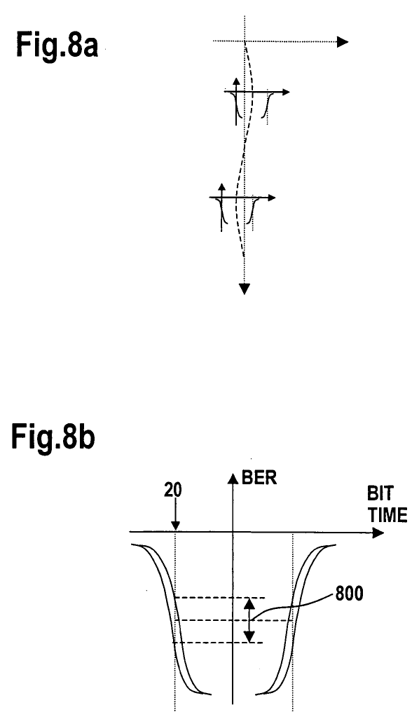

Therefore, when the Fourier transform is deployed to the auto-correlation of the error signal caused by both random and sinusoidal jitter, the resulting power density spectrum shows the spectral information of the sinusoid in terms of a strong peak. The result of the respective simulation is shown in FIG. 7, with the frequency of the sinusoidal modulation 460 appearing as a peak.

The fact that the power density of the random portion gets distributed over many frequencies while the spectral power of the sinusoidal portion stays concentrated in a single line significantly enhances the detection of spurious periodic jitter deeply buried in random jitter. Thus even small sources of deterministic jitter can be identified.

The influence of the position of the sampling point 20 is explained schematically in more detail in FIGS. 8A and B. The distribution of a composite jitter modulation signal consisting of random and sinusoidal jitter on the error rate can be perceived as a sinusoidally shifted Gaussian distribution. This means also that a virtual purely random BER curve is moving sinusoidally left and right on the bit time axis (x-axis in FIG. 8B) due to the sinusoidal component. Therefore the depth of error density modulation 800 depends on the steepness of the BER curve at the strobe point (the sampling point 20) provided the sinusoidal component is small. From this consideration follows. that the optimum sensitivity can be obtained with the sampling point 20 offset by 0.5UI (UI=Unit Interval) from the data eye center (as shown in FIGS. 1 and 4) or respectively from the center of gravity of the jitter histogram.

The aforedescribed ways to analyze composite jitter containing deterministic (periodic) and random jitter and to decompose it into its spectral components, has been shown particularly useful for design validation and debugging when the jitter frequencies of the deterministic portions are unknown.

In case, however, when it is already known or expected that a problem caused by deterministic jitter of a well-known frequency may exist, a pass/fail test might be provided useful e.g. for production testing. A typical case might be e.g. when process variations or other manufacturing defects result in jitter crosstalk from a known source. Such pass/fail test might be applied in a production test-flow to test for the occurrence of such faults for the deterministic jitter.

In one embodiment to determine the existence of a jitter with known frequency for pass/fail testing or to quantify jitter of a known frequency contained in a mix of random and deterministic jitter, a cross-correlation function (or covariance) is determined between the error signal and a sine wave of the expected frequency. Alternatively, another deterministic signal representing the potentially occurring jitter frequency can be used instead of a pure sine wave for calculating the cross-correlation. In case the deterministic signal is contained with the given frequency in the error signal and thus in the composite jitter of the data signal, the cross-correlation function will show up with a strong signal of the expected frequency. A Fourier transform of the cross-correlation signal may then show a strong peak at that frequency. When it is not contained in the composite jitter the cross-correlation function will show only a negligible signal induced by the noise and thus the Fourier transform will only show a minimal excitation.

1. A method for providing a jitter analysis for a digital signal having transitions between logical levels, the method comprising:
receiving a plurality of error values, each error value being associated with one of a plurality of successive timing points, and each error value being derived from a comparison of a result of a detection for a transition occurring in the digital signal at its associated timing point with an expected signal,
providing an error signal representing the derived error values relative to their respective timing points, and
providing a spectral jitter analysis for the error signal in order to detect spectral components in the error signal.

2. The method of claim 1, further comprising:
first providing, at each one of the plurality of successive timing points, a detection for a transition occurring in the signal at that timing point, and
then, for each one of the plurality of successive timing points, comparing a result of the detection with an expected signal and deriving an error value therefrom.

3. The method of claim 1, wherein providing a spectral jitter analysis for the error signal comprises at least one of: applying an auto-correlation, a cross-correlation, or a Fourier-Analysis to the error signal.

4. The method of claim 1, wherein each error value represents a matching information between a detected transition or non-transition and an expected transition or non-transition for the respective timing point.

5. The method of claim 1, wherein the error signal represents the plurality of the derived error values, each error value being associated with its respective timing point.

6. The method of claim 1, wherein the error signal represents the variation of the error values over the time or any other scale derived from the timing points.

7. The method of claim 1, further comprising evaluating a quantitative presence of a spectral jitter component in the digital signal.

8. The method of claim 7, further comprising providing a pass/fail test by comparing the evaluated quantitative presence of the spectral jitter component with a given threshold value.

9. The method of claim 8, wherein the pass/fail test fails, if the evaluated quantitative presence of the spectral jitter component exceeds the given threshold value.

10. The method of claim 1, wherein the timing points are selected in ranges wherein transitions are likely.

11. The method of claim 10, wherein the timing points are selected substantially in the middle of such ranges wherein transitions are likely under the influence of jitter.

12. The method of claim 1, wherein transitions in the digital signal are related to a reference signal having a reference frequency, and a distance between successive timing points is derived from the reference frequency.

13. A method for providing a jitter analysis for a digital signal to be measured having transitions between logical levels, the method comprising:
providing, at each one of a plurality of successive timing points, a detection for a transition occurring in the digital signal at that timing point,
for each one of the plurality of successive timing points, comparing a result of the detection with an expected signal and deriving an error value therefrom,
providing an error signal representing the derived error values relative to their respective timing points, and
providing a spectral jitter analysis for the error signal in order to detect spectral components in the error signal.

14. A software program or product, stored on a data carrier, for executing the method of claim 1 when run on a data processing.

15. An apparatus for providing a jitter analysis for a digital signal having transitions between logical levels, comprising:
a signal generation unit being adapted for receiving a plurality of error values, each error value being associated with one of a plurality of successive timing points, and each error value being derived from a comparison of a result of a detection for a transition occurring in the digital signal at its associated timing point with an expected signal, the signal generation unit being further adapted for generating an error signal representing the derived error values relative to their respective timing points, and
an analysis unit being adapted for providing a spectral jitter analysis for the error signal in order to detect spectral components in the error signal.

16. An apparatus for providing a jitter analysis for a digital signal having transitions between logical levels, comprising:
a detector adapted for providing, at each one of a plurality of successive timing points, a detection for a transition occurring in the digital signal at that timing point,
a comparator adapted for comparing, for each one of the plurality of successive timing points, a result of the detector with an expected signal and deriving an error value therefrom,
a signal generation unit being adapted for generating an error signal representing the derived error values relative to their respective timing points, and
an analysis unit being adapted for providing a spectral jitter analysis for the error signal in order to detect spectral components in the error signal.
